(19) United States
(12) Patent Application Publication
(10) Pub. No.: US 2009/0177499 A1
(43) Pub. Date: Jul. 9, 2009

(54) Method of and system for determining insurance claim losses

(76) Inventors: Steig Gunnar Westerberg, Laguna Hills, CA (US); Donald James Cahill, Scottsdale, AZ (US); Richard William Brady, Norcross, GA (US)

Correspondence Address: Steig Gunnar Westerberg, 27203 Woodbluff Rd., Laguna Hills, CA, 92653, US

(21) Appl. No.: 12/317,502

(22) Filed: Dec. 24, 2008

Related U.S. Application Data
(60) Provisional application No. 61/009,077, filed on Dec. 26, 2007.

(51) Int. Cl. G06Q 40/00; G06Q 90/00

(52) U.S. Cl. 705/4

(57) ABSTRACT

A system for and method of determining insurance claim losses. The method is comprised of inputting a claim loss item into a remote computational device. The claim loss item is communicated to a claims server, where a data source is searched for comparable items. The data source can be a local database or online sources such as an Internet URL and can return one or more exemplary items. The search for the exemplary items can incorporate filters. The exemplary items are displayed for an adjustor to select the item. The information associated with the exemplar item is stored for later display and report generation. A report can be generated displaying all of the information about the selected items.

### RELATED APPLICATIONS

This application is a utility patent application which claims priority under 35 U.S.C. § 119(e) of the co-pending, co-owned United States Provisional Patent Application, Ser. No. 61/009,077 filed Dec. 26, 2007, and entitled “METHOD OF AND SYSTEM FOR DETERMINING INSURANCE CLAIM LOSSES” and is hereby incorporated by reference in its entirety.

### FIELD OF THE INVENTION

The invention relates to methods of and systems for evaluating and determining insurance claim losses using a computer automated system to determine replacement cost from networked sources.

### BACKGROUND OF THE INVENTION

Insurance claims have been evaluated paid by an insurance agent using catalogs to determine the approximate cost of a category of an item. This technique inherently provides information that is out of date and generalized to what is specific make and model of an item. The catalog value can be either over or under the current market price for an item. Further, sometimes the insurance agent will only take the word the person incurring the loss to as to the value of the lost item. What is needed is a system for a claims adjustor to determine the replacement value for items in an insurance loss and to track the items for a claim where real time data can be obtained for replacement items, tracked and entered.

### SUMMARY OF THE INVENTION

A method of and system for detecting memory resident malicious software based on critical address space protection. The method detect software running in memory segments with unexpected memory attributes by capturing attempts to located and access critical system resources.

In a first aspect of the invention, a method of detecting a processor executing memory resident malicious code comprises the steps of configuring a critical memory address with a memory attribute that causes an exception. The exception can be a hardware interrupt to the processor and can call a software routing called an exception handler. In another step, the exception handler is configured to check the memory attributes of the instruction that caused the attribute. The system can be configured with a standard exception handle. The configuring to check the memory attributes can be performed through operating system provided hook to add to the configuration

### BRIEF DESCRIPTION OF THE DRAWINGS

The invention is better understood by reading the following detailed description of exemplary embodiments in conjunction with the accompanying drawings.

FIG. 1 illustrates a system of insurance claim processing.

FIG. 2 illustrates a memory storage scheme for data associated with insurance claims processing.

FIG. 3A illustrates a form for inputting an item for a claim.

FIG. 3B illustrates the specific product response for a general product inquiry.

FIG. 3C illustrates a claim entry form in accordance with the present invention.

FIG. 4 illustrates one embodiment of the processing steps for continuing the code execution from the exception point.

FIG. 5 illustrates a block diagram of an exemplary computing device configured to determine the insurance claim losses.

### DETAILED DESCRIPTION OF THE INVENTION

The following description of the invention is provided as an enabling teaching of the invention in its best, currently known embodiment. Those skilled in the relevant art will recognize that many changes can be made to the embodiment described, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present inventions are possible and can even be desirable in certain circumstances, and are a part of the present invention. Thus, the following description is provided as illustrative of the principles of the present invention and not in limitation thereof, since the scope of the present invention is defined by the claims.

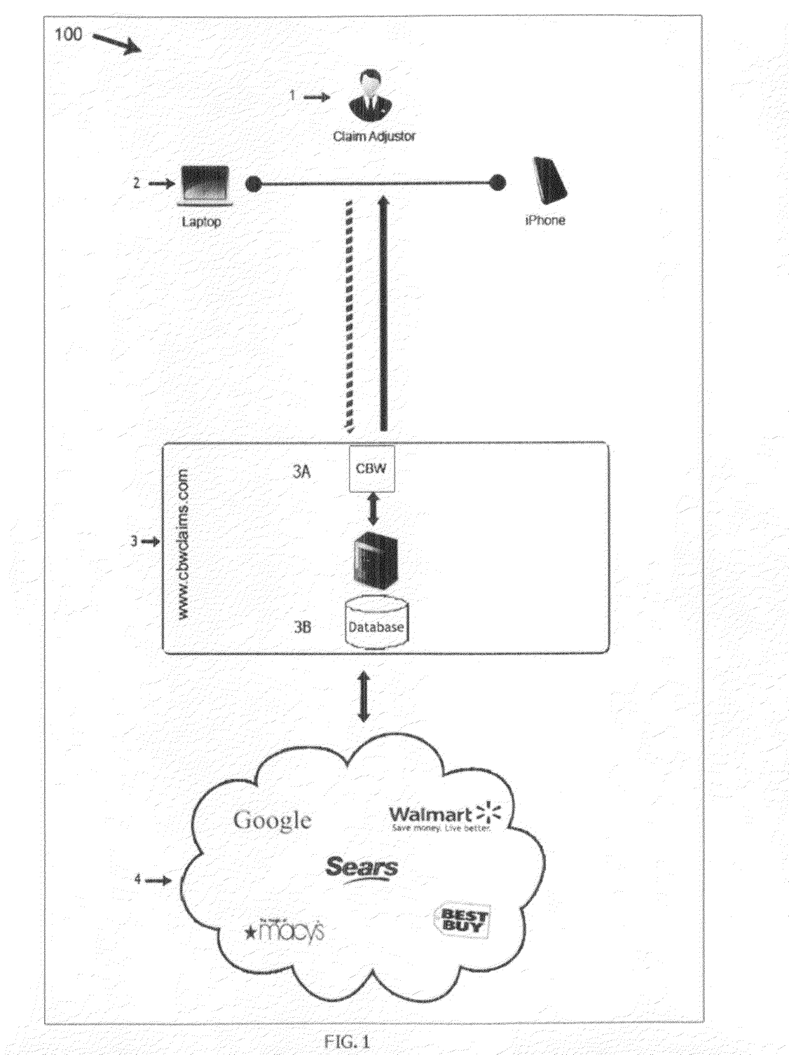

FIG. 1 shows a system for the determining insurance claim losses. The system 100 is comprised of a remote device 2, in communications with a server 3 configured to determine insurance claim losses. The server 3 is configured with a database with locally stored information regarding product information or can communicate with the internet and online stores to obtain product information from online stores. The server 3 of the invention may be implemented on any functionally compatible network and accessed via the World Wide Web on any general-purpose computer device that is web enabled and includes a web browser such as a PC or iPhone 2.

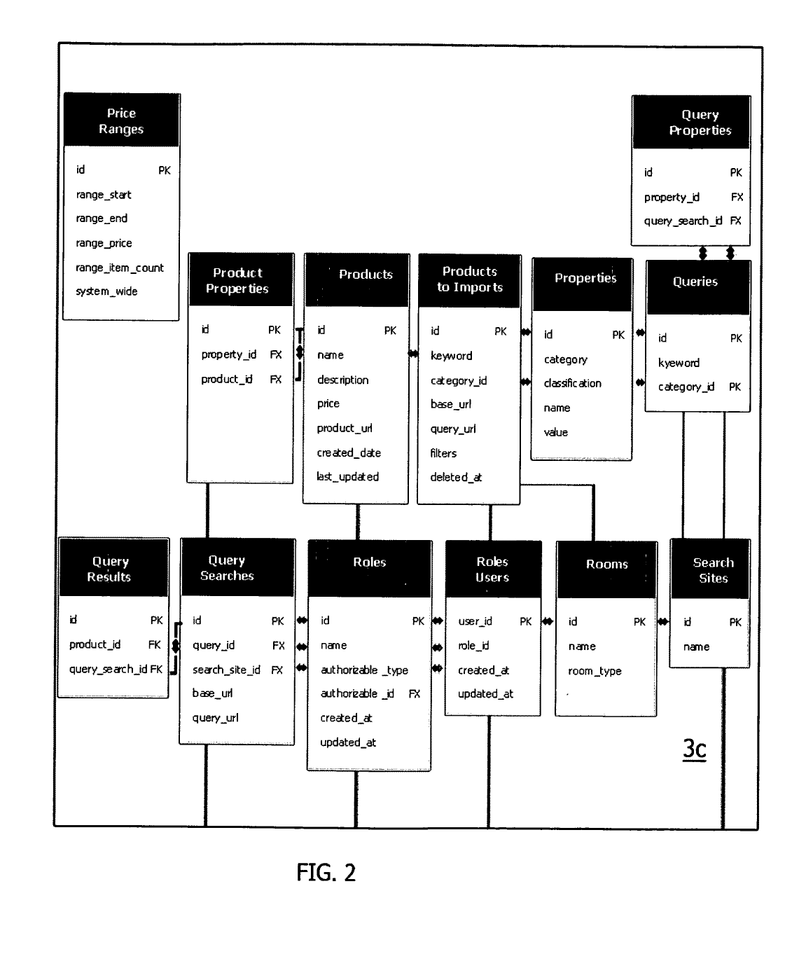

FIG. 2 shows an exemplar data scheme for determining insurance claim losses. The schema can contain information about a claim loss, individual items lost, filter information, comparable items found on the database or the Internet, and related information associated with the replacement item.

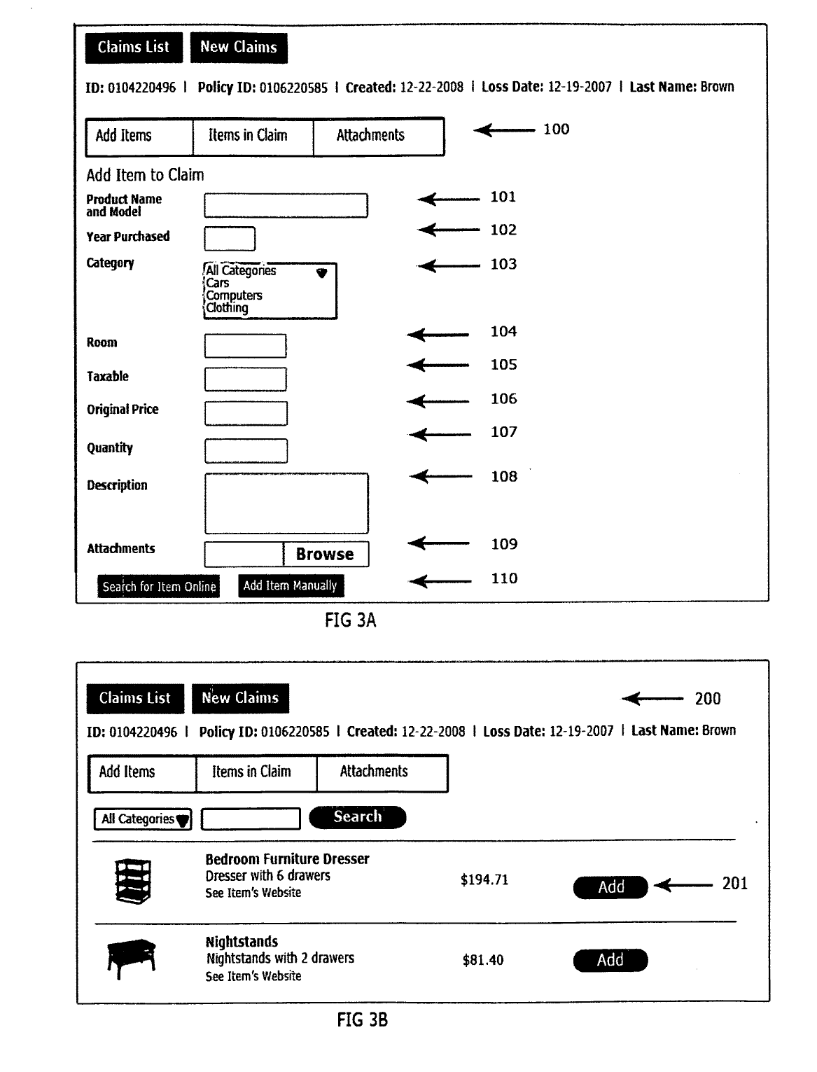

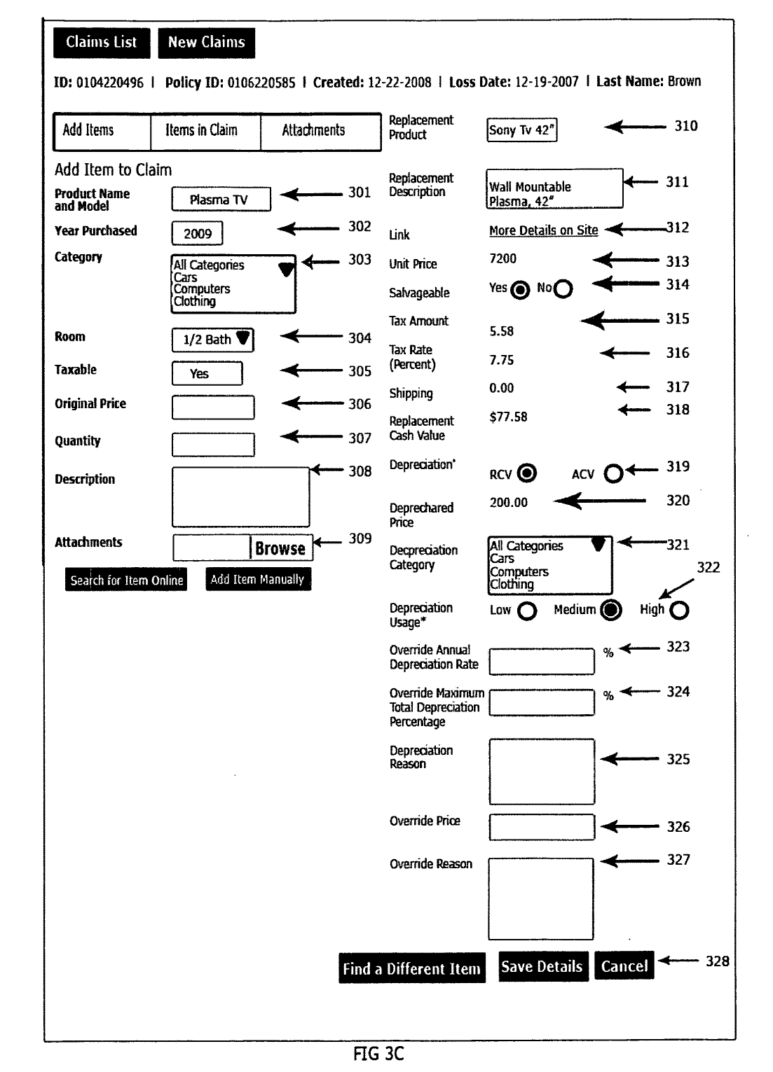

FIGS. 3A and 3B are exemplary graphical user screens for inputting claim information including product descriptions. The information is used to search for replacement items. The graphical user interface can include adding attachments for an item 100, a product name 101, the year purchased 102, a category of items 103, room information 104, whether the item is taxable 105, the original price 106, the quantity 107, a description 108, and any attachments 109. FIG. 3B illustrates a graphical user interface after inputting claim items and configured to add another item to a claim that has a couple of items displayed and available for selection.

Searches are executed when a user minimally enters a product description 101, the purchase year 102 and the search for item online button is clicked 110. Optionally users can enter any of the fields in 103 to 109 before searching. On clicking search for item online 110 the system searches its local product tables 3c and the Internet directly using a variety of search engines and online retailers 4. Search results from all sources are then displayed in 200 and are sorted by relevancy.

Users can select the item whose value they would like to use for the claims by clicking add 201 and the system will record the URL and a screen shot of the page displaying the item in its database 3b so all parties can review the information at a later point. Additionally the selected product and associated metadata are added to the systems product tables 3c to be included in future local searches.

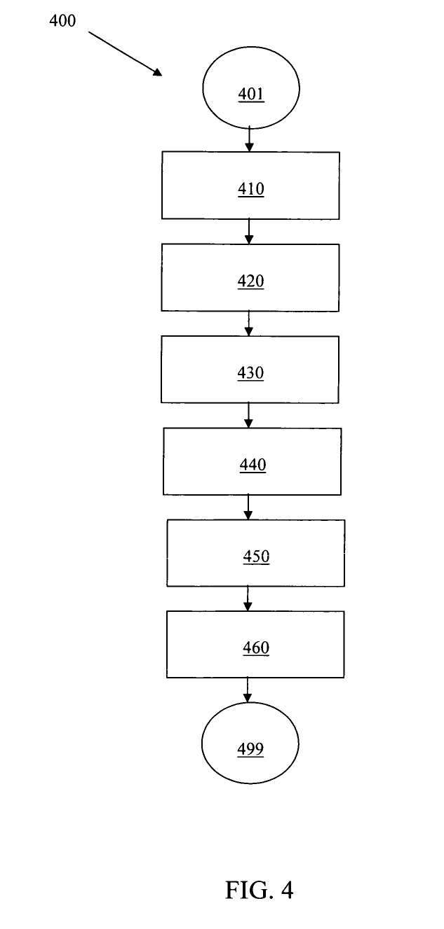

FIG. 4 shows a method for providing a method for online determination for insurance claims losses personal and business property claims. The method is comprised of the steps of configuring a computational system to track a claims associated to a group, configuring the computational system to accept claims from specified adjustors, and receiving claims.

The method begins at Start 401. In a first step 410, the process is started by the configuration of the computational system for an organization. The configuration of the organization can include the organization name, organization type, the address, and information about managing the data such as how long the data is to be stored. The insurance firm can include information about whether the organization is an independent adjuster. Further, the organization information can include payment information and branch information. Preferable the system is configured using a data base.

In a second step 420, the computational system is configured for a remote computational device to input claim information associated with an organization and based on authorized adjuster identification. The system is configured such that Adjusters can only see their own claims. The system is also configured to enable a hierarchical viewing of claim information including a Branch administrator that can view as subset of adjustor entered claims, and an organization administrator that can access all the claim information associated with the Adjusters associated with an organization. Preferably the claim information is searchable. Claims can be searched for by Claim Number, Policy Number, Policy Holder's Last Name and Zip Code.

The claim information, Adjustor information, and Organization information is stored in non-volatile memory. Claim information can be purged or archived automatically. The purging or archiving can be triggered manually by operator input, can be scheduled, or can occur periodically. Further, a claim can be purged if not referenced after a certain time period.

In a step 430, the computational system is configured with one or more adjusters. Each adjustor is associated with a branch that is associated with an organization. The adjuster can be identified by the type in their email address. Further, the configuration of the system can be provided with communication, including but not limited to emails, to an adjustor with a request to generate an electronic response that provides the Adjustors information that is configured into to the computation system. The Adjustor can either by application, a URL, or response email send response used by the system to configure the system with the Adjustors information. The information can include but is not limited to a First Name, Last Name, Phone, Cell Phone, Fax, Email, address information. This information can be used in the reports the Application produces as well as to provide printed or electronic map information to provide of directions from the Adjuster's address to a Claim Address.

In a step 440, the computational system receives claim information which is stored into non-volatile memory that can include a database. The claim information can includes the date claim is entered into the Application, a branch claim is assigned to, a Claim Number, a policy Number, a type of low (including theft, water, wind, fire, flood, or a operator entered type, a claim type include personal or commercial, the date of the loss, facts about the of loss, and sales tax rate applicable to address of loss. If the Organization Type is any type except Insurance Company, we also ask the name of the Insurance Company (carrier) of the insured party. By doing so, we can load that Insurance Company's specific deprecation rates and include their logo on the report(s).

Further, the claim information can include room specific information to either a residence or commercial building for aggregating losses in reports. Also, the claim information can include policy holder information including last name, first name, home phone, work phone, cell phone, email, address, city, state, and zip information.

The claims are configured to be modifiable in a hierarchical manner depending on the permissions associated with entity doing the modification. A change step associated with the permission level of adjustor can modify all claims associated with an adjustor's identity. The permission of a Branch administration can perform actions on all claims associated with the adjustors associated with the Branch administration. The permission level of Organization Administration can change all claims associated with the claims under and the branch admin and all the associated adjustors. The type of changes that can be made include but are not limited to adding items to a claim, upload items to a claim, view a map of directions to the claim address, edit the facts of the claim, sending claim information to the insured party, deleting a claim, viewing a claim, generating various reports including losses for a room, a category, generating a report in the form of an excel spreadsheet, or exporting a report in on the categories of losses in the format of an Excel spreadsheet.

In operation, the step of adding an item to a claim can include prompting an adjustor with information about the claim loss. This information can include a product name and model, the year purchased, the room in which the loss occurred including but not limited to a ½ bath, ¾ bath, full bath, bedroom, den, dining room, entry, family room, garage, guest room, hallway, home office, kitchen, laundry room, living room, loft, master bedroom, master bathroom, master closet, and patio. For commercial property, the room information can include whether the room is a file room, hall, kitchen, ladies bathroom, mens bathroom, lobby, office, storage room, store room, or warehouse. Further, the claim item is taxable, its original purchase price, quantity, description, and documents or picture related to the claim.

In a step 450, the Adjuster can invoke a search of either a local database or through a network to online sites for a match to the lost item. Assuming a network based online search is chosen, then the Application uses the information already entered as described (above) to search the database as well as the Internet for matches. The results can be displayed and the search can be further refines the results through a series of filters. Filters can be dynamic in that they can be configured specific to the item being searched. Exemplary of these filters are a price range, a brand, a store, a material, a product type, a style, and a category type for a search for a Tiffany Lamp. Exemplary of a search for a Flat Panel TV could be a filter for a price range, room type, viewing distance, screen size, aspect ratio, flat panel type, brand, condition, and broadcast format. Once the adjuster narrows the search down, they can view specific store's web pages and product descriptions and makes a final choice.

In a step 460, information regarding the selected item is captured and stored in a format compatible for report generation. This information about the selection item, the replacement product, can be taken form an source coupled to a network including retailer websites, a URL for the information, the web site price, a unit price, a salvageable price, sales tax information, sales tax rates, shipping costs, the type of claim, replacement cash value (RCV) or actual cash value (ACV), the type of depreciation to be used, the usage of the item, and whether the depreciation or price is over ridden. Note that all over rides can be documented as to why it is being over ridden. Branch and Org Administrators can view reports showing how Adjusters are over riding claims and how they are choosing items; e.g. are they choosing the least expensive items or not.

As noted above, pictures or documents can be tied to specific claim items. But in addition, pictures and documents can be tied to a claim in general through an upload feature. These all are incorporated into the PDF reports.

A snapshot of the retailers web page that has the item chosen for inclusion in the claim is taken and incorporated into the PDF report. Reports can be generated in multiple formats. The reports can include but are not limited attachments that can include pictures, scans of documents, or generate reports in the form of excel spread sheets or in a PDF format.

A spreadsheet has been prepared that contains all the rooms and types of claims contained in the Application. It can be completed and then uploaded to the system for online searching for pricing. This spreadsheet enables the adjuster to provide a tool the insured party can use to aid in the collection of the inventory of items to be included in the claim.

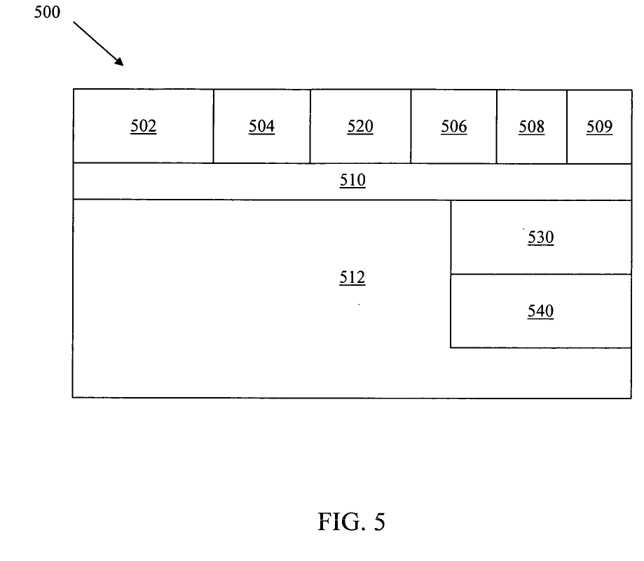

FIG. 5 illustrates a block diagram of an exemplary programmable device 500 configured to implement a method for determining insurance claim losses. The computing device 500 can be server providing network services where remote client computing devices in communications with the server can input claims to determine claim losses. The computing device 500 can receive service requests that include an new claim, inputting a new item for which to determine a loss, and generating reports at a claim, an office, or insurer level. The computing device 500 can include a storage system 512 for program and data storage. The data storage can include web pages, files, databases, and e-mails. The storage of the insurance claim loss code can be stored on separate devices or on the same device as the computing device. For example, the code for the denial-of-service or other exploitation protection can be stored on a tape, a local hard drive, CD-ROM, a DVD, or solid state memory. Further, the computing device 500 can communicate with other computational systems including a human interface such as a graphical user interface. The communication can be through a network, direct communication through a dedicated communication link, or through an operating system communication channel such as a socket. In general, a hardware structure suitable for implementing the computing device 500 can include a network interface 502, a memory 504, a memory management unit (MMU) 520, a processor 506, I/O device(s) 508, a bus 510 and a storage device 512. The choice of processor is not critical as long as a suitable processor with sufficient processing power is chosen. The memory 404 can be any conventional computer memory known in the art. The storage device 512 can include a hard drive, tape, CDROM, CDRW, DVD, DVDRW, flash memory card or any other storage device. The computing device 500 can include one or more network interfaces 502. An example of a network interface includes a network card coupled to an Ethernet or other type of LAN. The I/O device(s) 508 can include one or more of the following: keyboard, mouse, monitor, display, printer, modem, touchscreen, button interface and other devices including remote systems. The code for the insurance loss determination 540 can be a component separate from the OS 530. Additionally, code for the detection of a system exploitation 560 can be found on the storage. More or fewer components shown in FIG. 5 can be included in the computing device 500. Additional processors, either distributed or not distributed, and additional storage can be incorporated.

Reference has been made in detail to the preferred and alternative embodiments of the invention, examples of which are illustrated in the accompanying drawings. While the invention has been described in conjunction with the preferred embodiments, it will be understood that they are not intended to limit the invention to these embodiments. On the contrary, the invention is intended to cover alternatives, modifications and equivalents, which can be included within the spirit and scope of the invention. Furthermore, in the detailed description of the present invention, numerous specific details have been set forth in order to provide a thorough understanding of the present invention. However, it should be noted that the present invention can be practiced without these specific details. In other instances, well known methods, procedures and components have not been described in detail as not to unnecessarily obscure aspects of the present invention.

What is claimed is:

1. A method of processing insurance claims:
inputting a claim loss item into a remote computational device;
communicating the claim loss item to a claims server;
searching one or more data sources;
displaying one or more related items found in the data sources;
receiving a related item selection indication;
storing information related to the related item selection indication; and
storing the related item selection and associating the related item selection with the claim loss item.

2. The method of claim 1, wherein the storing the information related to the related item selection is a snapshot of a web page displaying the related item selection.

3. One or more processor readable storage devices having processor readable code embodied on the processor readable devices for programming one or more processors to perform a method of determining insurance claim losses comprising the steps of:
inputting a claim loss item into a remote computational device;
communicating the claim loss item to a claims server;
searching one or more data sources;
displaying one or more related items found in the data sources;
receiving a related item selection indication;
storing information related to the related item selection indication; and
storing the related item selection and associating the related item selection with the claim loss item.
